(19) United States
(12) Patent Application Publication
(10) Pub. No.: US 2008/0307324 A1
(43) Pub. Date: Dec. 11, 2008

(54) SHARING CONTENT IN A VIDEOCONFERENCE SESSION

(75) Inventors: Peter Westen, Mountain View, CA (US); Marcel MWA van Os, San Francisco, CA (US); Jean-Pierre Ciudad, San Francisco, CA (US)

Correspondence Address: FISH & RICHARDSON P.C., PO BOX 1022, MINNEAPOLIS, MN, 55440-1022, US

(73) Assignee: Apple Inc.

(21) Appl. No.: 12/014,047

(22) Filed: Jan. 14, 2008

Related U.S. Application Data
(60) Provisional application No. 60/943,032, filed on Jun. 8, 2007.

(51) Int. Cl. G06F 3/00

(52) U.S. Cl. 715/753

(57) ABSTRACT

A videoconferencing participant can share content with other participants seamlessly and effortlessly. A consistent user interface is used to present content no matter what type of content is being shared. Navigation controls allow a participant in the videoconference session to control what content is being displayed. The particular navigation controls provided are sensitive to the type of content being shared.

### RELATED APPLICATION

This application claims the benefit of priority from U.S. Provisional Patent Application No. 60/943,032, filed Jun. 8, 2007, for “Sharing Content In A Videoconference Session,” which provisional patent application is incorporated by reference herein in its entirety.

### TECHNICAL FIELD

This disclosure generally relates to videoconferencing.

### BACKGROUND

Videoconferencing systems allow a user to share video and audio streams with other participants of a videoconference session. The video and audio streams are presented to each participant. While in a videoconference session, some systems allow a user to transfer a file to other participants. When a file has been received by a participant, the participant can invoke an application associated with the file to view the contents of the file. In such a system the user that has transferred the file typically has no control over how other participants view the file.

Other videoconferencing systems allow a user to share a representation of an application that the user is using with participants of a videoconference session. In such systems, images of the user's application are sent and displayed to participants of the video conference. Whenever the content that is currently being displayed by the application is changed a new image of the application is sent to participants. For participants, the display of the user's application may overlap or otherwise obscure the presentation of the video streams from other participants in the video conference.

### SUMMARY

Particular embodiments of the subject matter described in this specification can be implemented to realize one or more of the following advantages. A videoconferencing participant can share content with other participants seamlessly and effortlessly. A consistent user interface is used to present content no matter what type of content is being shared. Navigation controls allow a participant in the videoconference session to control what content is being displayed. The particular navigation controls provided are sensitive to the type of content being shared.

The details of one or more embodiments of the invention are set forth in the accompanying drawings and the description below. Other features, aspects, and advantages of the invention will become apparent from the description, the drawings, and the claims.

### BRIEF DESCRIPTION OF THE DRAWINGS

FIG. 1 illustrates a computer desktop of a user participating in a videoconference application.

FIG. 2 illustrates the display and navigation of shared content in an example videoconference window.

FIG. 3 illustrates the display of shared content in an example content recipient's videoconference window.

FIG. 4 is a block diagram of an example of an architecture for videoconference communications.

FIG. 5 shows a flowchart for an example method for transmitting content and navigation operations on content to a recipient of a videoconference.

### DETAILED DESCRIPTION

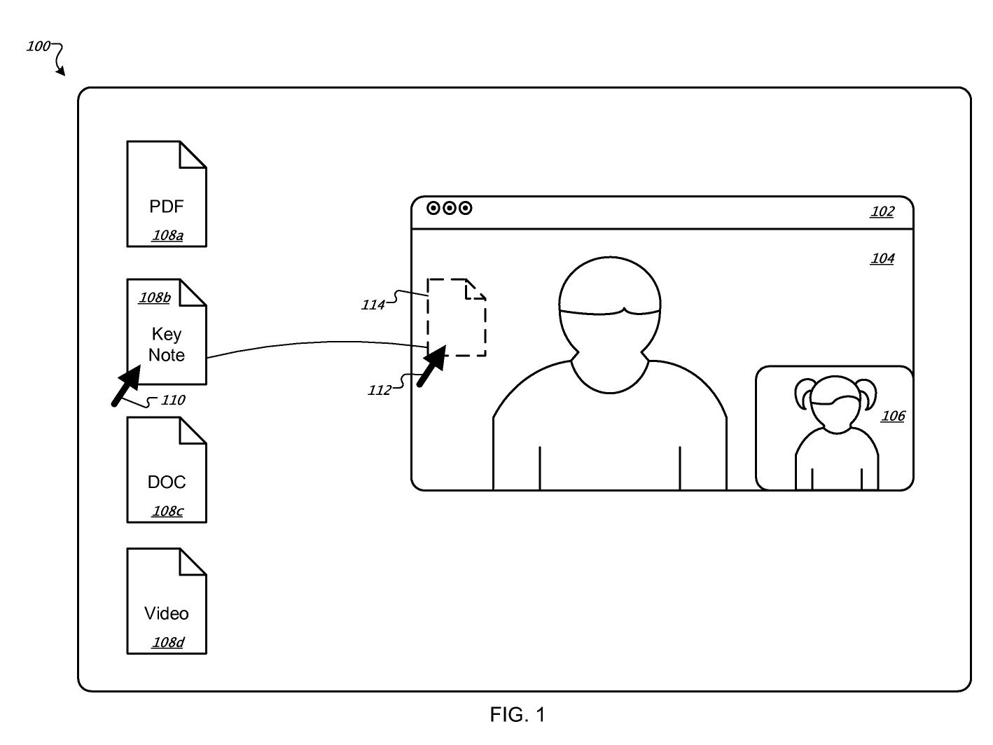

FIG. 1 illustrates a computer desktop 100 of a user participating in a videoconference application. A computer desktop is the background area of a computer display screen, on which windows, icons, and other graphical user interface items can appear. A graphical user interface (GUI) is a user interface based on graphics (e.g., icons, pictures, menus, etc.) in contrast to a user interface based solely on text. The desktop 100 includes a videoconference window 102 which shows a videoconference session between the user's computer and a computer of a videoconference participant. The user of the desktop 100 will hereafter be referred to as the “content sender”, other videoconference participants will hereafter be referred to as the “content recipients”. The videoconference window 102 includes a video area 104 for presenting a video representation of the content recipients to the user. The videoconference window 102 also includes a preview area 106 for presenting a video representation of the user. A user can use the preview area 106 to observe a representation of him or herself as would be seen by the content recipient. Similarly, a corresponding desktop of the content recipient can have a videoconference window which includes a video area for presenting a video representation of the content sender. The content recipient's videoconference window can also have a preview area where the content recipient can observe a presentation of him or herself as would be seen by the content sender.

The desktop 100 can include one or more file icons, such as icons 108a-d. Each icon 108a-d represents a file including content of a particular content type. For example, the file represented by icon 108a includes PDF (Portable Document Format) desktop-publishing content, the file represented by icon 108b includes slide presentation content, the file represented by icon 108c includes word processing content, and the file represented by icon 108d includes video content (e.g., MPEG (Moving Picture Experts Group), AVI (Audio Video Interleave)). Other content types are possible, including, but not limited to, audio (e.g., WAV (Waveform audio format), MP3 (MPEG-1 Audio Layer 3), AAC (Advanced Audio Coding), etc.), images (e.g., GIF (Graphics Interchange Format), JPEG (Joint Photographic Experts Group), PNG (Portable Network Graphics) and TIFF (Tagged Image File Format)), file folders, address book contacts, text documents (e.g., RTF (Rich Text Format), plain text), HTML (Hypertext Markup Language), spreadsheets, and email messages.

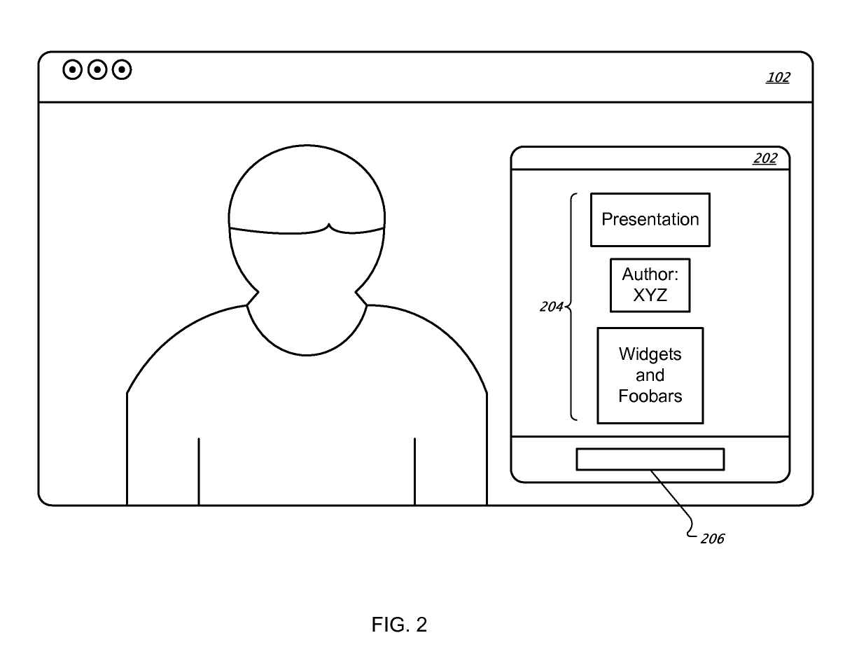

A user can share content (either the entire contents, or a part of the content) of a file, such as the file represented by icon 108b, with videoconference participants. The user can specify a file to share with a participant of an videoconference by, for example, dragging and dropping a representation of a file into the videoconference window 102. For example, the user can select the icon 108b (as illustrated by a mouse cursor 110), and drag and drop the icon 108b onto the window 102 (as illustrated by mouse cursor 112 and a “dashed-line” file icon 114). When the icon 108b is dropped onto the window 102, the contents of the file represented by icon 108b are shared with the participants of the videoconference session represented by the window 102. When the content of files are shared, some or all of the content in the file is presented simultaneously to all participants of the videoconference, as further described in reference to FIG. 2. Other methods of identifying a file to share can be used, such as “copying and pasting” a file icon, or browsing for and selecting a file in a file selection window. In general, the content selected for sharing need not be contained in a file. For example, in some implementations, a user can select a record in a database that contains a particular desirable type of content.

FIG. 2 illustrates the display and navigation of shared content in an example videoconference window 102. The videoconference window 102 includes a content viewer window 202. The content viewer window 202 displays a representation of content 204 transferred to and shared with the content recipient (e.g., the content sender can share a file, such as the file represented by icon 108b, with the content recipient (a participant in the videoconferencing session) by dragging and dropping the file icon onto the window 102). For example, the content 204 displayed in the content viewer window 202 can be a representation of slide presentation content from a presentation document stored in a file represented by icon 108b. The content viewer window 202 can appear in response to the sharing of content with the videoconference participants.

The content viewer window 202 can display a number of types of content, such as video, image, text, word processing, etc. The content viewer window 202 can display content 204 without launching the application used to create the content 204. For example, the content viewer window 202 can display slide presentation content without launching the presentation software program used to create the presentation. As another example, the content viewer window 202 can display word processing content without launching the word processor program used to create the content. The content presented by the content viewer window 202 can be read, analyzed and presented by a single application (or component) capable of presenting the content of varying content types. For example, HTML content is presented by the same application as image content and as presentation slide-show content. The content viewer window 202 can correspond to an application or content preview framework for previewing the content of files, such as described in U.S. patent application Ser. No. 11/499,017, filed Aug. 4, 2006, Attorney Docket No. P4457, entitled “Methods and Systems for Managing Data,” which patent application is incorporated by reference herein in its entirety.

The videoconference window 102 is a view from the content sender's perspective (e.g., a view from the perspective of the user that initiates sharing of content). The content viewer window 202 includes a navigation control panel 206 which can include one or more controls which allow the content sender to perform one or more navigation operations to navigate through the content 204. The navigation controls displayed in the navigation control panel 206 can be based on the type of content 204. For example, navigation controls for slide presentation content can allow the content sender to advance slides in a presentation. Other types of navigation controls can be used for other content types. For example, navigation controls for video content can allow the content sender to start, stop and pause a video. As another example, navigation controls for word processing content can allow the content sender to scroll through and/or page up or down through a document.

In response to the content sender using the navigation control panel 206 to navigate through the content 204, the presentation of the content 204 can be updated for all videoconference participants to reflect the navigation operation(s) performed by the content sender. For example, a slide presentation can be advanced to the next slide, a video stream can be paused, etc. The navigation operation(s) can be sent to the content sender, so that the display of the content 204 as seen by other participants can also be updated.

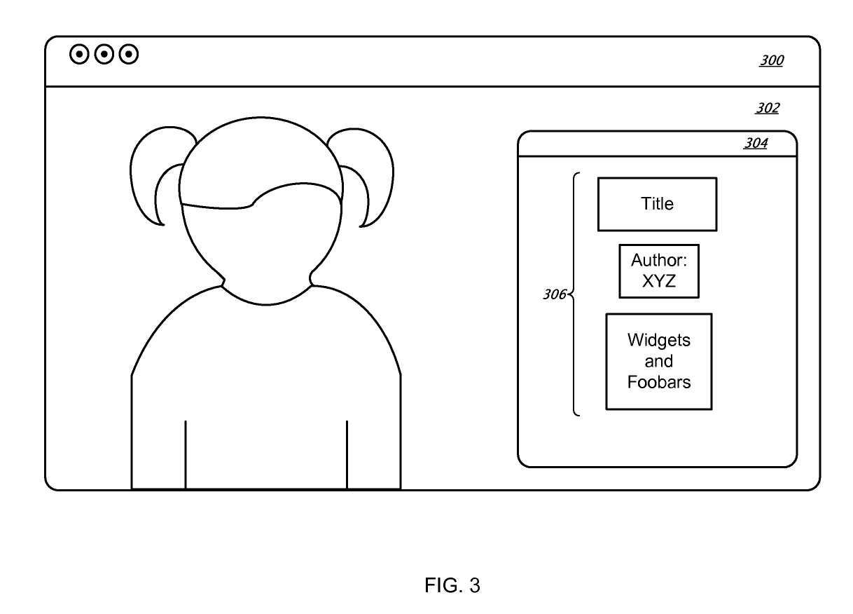

FIG. 3 illustrates the display of shared content in the content recipient's videoconference window 300. The videoconference window 300 includes a video area 302 for displaying a video representation of the content sender (or other participants of the videoconference). The videoconference window 300 can optionally display a preview area for displaying a video representation of the content recipient.

The videoconference window 300 can include a content viewer window 304 for displaying content received from and shared by the content sender. For example, the content viewer window 304 can display content 306, such as slide presentation content shared from the file represented by icon 108b. Note that the content viewer window 304 of the content receiver can simultaneously present the same content as the content viewer window 204 of the content sender. The content viewer 304, like the content viewer 202, is a generalized content viewer. The content viewer window 304 can interpret and present multiple types of content, including PDF, slide presentation content, word processing content, video content (e.g., MPEG, AVI), images (e.g., GIF, JPEG, PNG and TIFF), file folders, address book contacts, text documents (e.g., RTF, plain text), HTML, spreadsheets, and email messages. The content viewer 304 can interpret and present multiple types of shared content without executing the applications used to create the content. For example, slide presentation content can be interpreted and presented without executing the slide presentation software used to create the presentation.

Although not shown in FIG. 3, in some implementations, the content recipient's videoconference window 300 can include a navigation panel allowing the content recipient to navigate through the transferred content 306. In some implementations, navigation by the content recipient affects the presentation of content for all participants of the videoconference. In other implementations, navigation by a content recipient only affects content being presented to the content recipient. In some implementations, a permissions system can be used so that the content recipient can request permission from the content sender to control navigation locally.

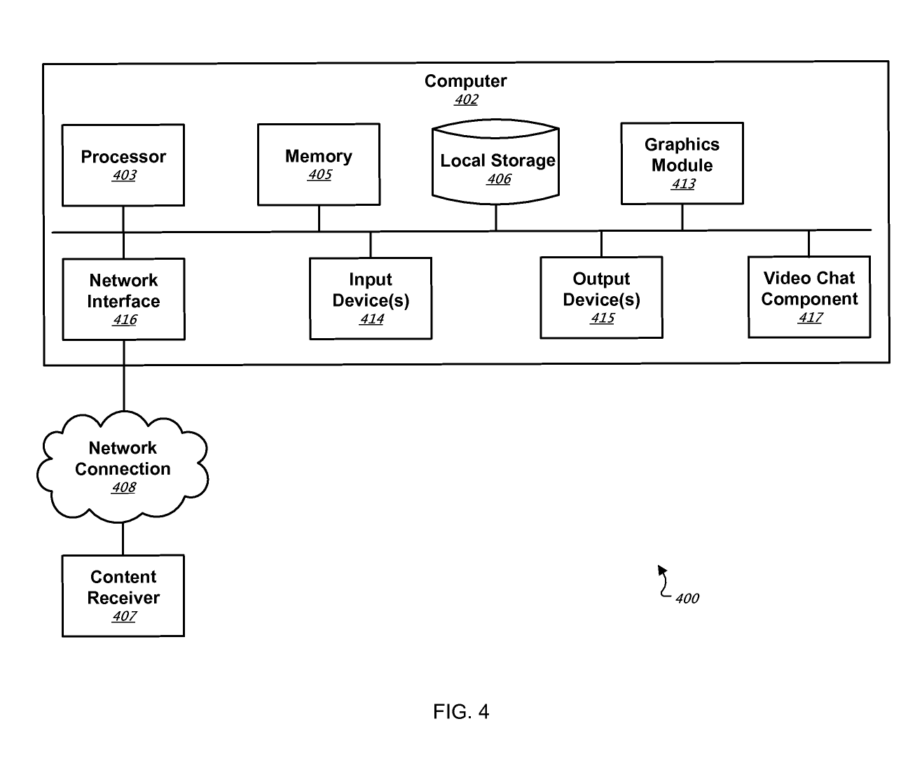

FIG. 4 is a block diagram of an architecture 400 (e.g., a hardware architecture) for videoconference communication. The architecture 400 includes a personal computer 402 communicatively coupled to a content recipient 407 via a network interface 416 and a network 408 (e.g., local area network, wireless network, Internet, intranet, etc.). The computer 402 generally includes a processor 403, memory 405, one or more input devices 414 (e.g., keyboard, mouse, video recording device, audio recording device, etc.) and one or more output devices 415 (e.g., a display device, speaker device). A user interacts with the architecture 400 via the input and output devices 414, 415. Architecture 400 as disclosed includes various hardware elements. Architecture 400 can include hardware, software, and combinations of the two.

The computer 402 also includes a local storage device 406 and a graphics module 413 (e.g., graphics card) for storing information and generating graphical objects, respectively. The local storage device 406 can be a computer-readable medium. The term “computer-readable medium” refers to any medium that includes data and/or participates in providing instructions to a processor for execution, including without limitation, non-volatile media (e.g., optical or magnetic disks), volatile media (e.g., memory) and transmission media. Transmission media includes, without limitation, coaxial cables, copper wire, fiber optics, and computer buses. Transmission media can also take the form of acoustic, light or radio frequency waves.

While videoconference communication exchanges are described herein with respect to a personal computer 402, it should be apparent that the disclosed implementations can be incorporated in, or integrated with, any electronic device that has a user interface, including without limitation, portable and desktop computers, servers, electronics, media players, game devices, mobile phones, email devices, personal digital assistants (PDAs), embedded devices, televisions, other consumer electronic devices, etc. In addition, the content recipient 407, while described herein with respect to another personal computer, can also be incorporated in or integrated with any electronic device that has a user interface.

Systems and methods are provided for videoconference communication. The systems and methods can be stand alone, or otherwise integrated into a more comprehensive application.

One of ordinary skill in the art will recognize that the engines, methods, processes and the like that are described can themselves be an individual process or application, part of an operating system, a plug-in, an application or the like. In one implementation, the system and methods can be implemented as one or more plug-ins that are installed and run on the personal computer 402. The plug-ins are configured to interact with an operating system (e.g., MAC OS® X, WINDOWS XP, LINUX, etc.) and to perform the various functions, as described with respect to the Figures. A system and method for videoconference communication can also be implemented as one or more software applications running on the computer 402. Such a system and method can be characterized as a framework or model that can be implemented on various platforms and/or networks (e.g., client/server networks, wireless networks, stand-alone computers, portable electronic devices, mobile phones, etc.), and/or embedded or bundled with one or more software applications (e.g., email, media player, browser, etc.).

The computer 402 includes a video chat component 417 that provides the user with the capability to communicate, for example with the content recipient 407, via video, audio and file-sharing exchanges. In some implementations, the video chat component 417 includes a video conferencing graphical user interface. It should be noted that document sharing is not limited to video chats and is also applicable to audio only chats, text chats, etc.

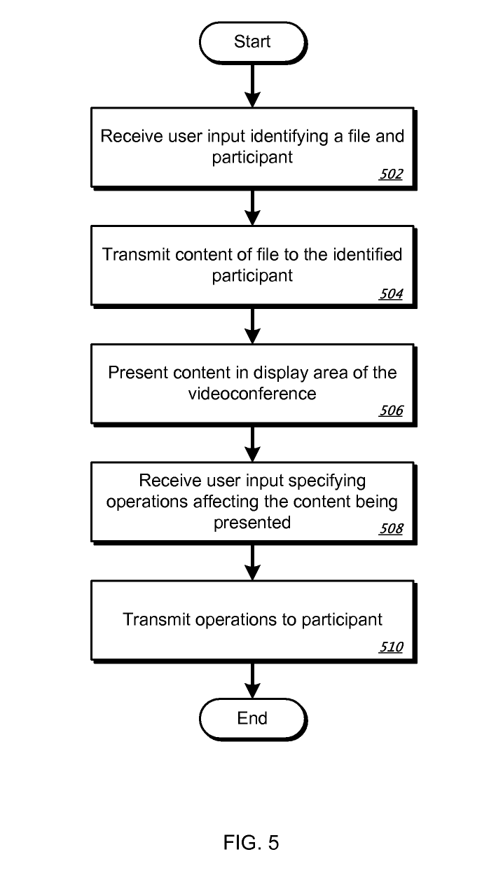

FIG. 5 shows a flowchart for an example method 500 for transmitting content and navigation operations related to the content to a recipient of a videoconference. First, user input identifying a content item (e.g., a file or portion of a file) and a participant are received (step 502). For example, a file, such as the file represented by icon 108a, can be identified by the content sender selecting a file (e.g., by clicking with a mouse). A participant of a videoconference can be identified, for example, by the content sender dragging and dropping a file icon onto a window (e.g., video area 104) used to present video of the participant in the videoconference session. As another example, the participant can be identified by the selection of a user input control (e.g., a menu or a button) on a window (e.g., video area 104) used to present video of the participant in the videoconference, and the file can be identified by the selection of a file from a file-selection window launched in response to the selection of the user input control. Other means for selecting content or the participant can be used.

Next, content of the file is transmitted to the identified participant (step 504). For example, the content sender can specify to share all or a portion of the content identified in step 502. In some implementations, the portion transmitted is a minimum portion of the identified content that is necessary to present a first page of the content to the content recipient. The content identified for sharing can be transmitted across the network connection 408, (e.g., a local area network (LAN), wide area network (WAN), the Internet, an intranet) using the network interface 416. The content can be received by a network interface of a remote device (e.g., content recipient 407) being used by the content recipient. The transmitted content can be saved to a local storage included in the remote device and/or can be loaded into memory included in the remote device.

Content is presented in a display area of the videoconference session (step 506). For example, the transmitted content can be displayed in the content viewer window 202 and in the content viewer window 304 (e.g., the content can be displayed within the videoconference window of both the content sender and the content sender, where the videoconference window represents the videoconference session between the two participants).

Next, user input specifying navigation operations affecting the content being presented is received (step 508). For example, the content sender can use controls in the navigation control panel 206 to navigate through content, such as advancing to the next slide in a presentation, paging down in a word-processing document, fast-forwarding in a movie, etc. The content presented in the each videoconference participant's content viewer window (i.e., content viewer window 202) can be updated to reflect the navigation operations.

Next, operations are transmitted to the participant (step 510). For example, one or more navigation operations on content corresponding to actions performed by the content sender using controls in the navigation control panel 206, such as slide-advance, page-down, pause, stop, and rewind operations, can be sent to the content recipient. In response to the receipt of the navigation operations, the content sender's view of the content can be updated accordingly. For example, content shown in the content recipient's content viewer window 304 can be updated to reflect the received operations.

In implementations where both the content viewer 202 and content viewer 304 include a navigation panel, various methods can be used to control who (i.e., the content sender or content recipient) has control over content navigation. An approach can be used where either the content sender or content recipient can navigate content. Alternatively, the initiator of the content sharing (e.g., the content sender) can initially control navigation, whereas the content recipient may have to ask for permission to navigate content. In another implementation, both the content sender and content recipient have to first ask for permission from the other participant before being allowed to navigate content. Navigation panels may be hidden (or, in some implementations, disabled) until permission is granted from the authorizing party (e.g., the other participant). Actions taken in the navigation panels on the recipient's side can be sent to the sender's side where the action from the sender can be applied and the content can be updated accordingly.

The transmission of shared content can be distinguished from the transmission of ordinary audio/video content of the videoconference. The shared content is seen by both participants, and if a navigation operation is performed, the displayed content is updated in both the content sender's content viewer window 202 and in the content recipient's content viewer window 304. In contrast, some audio/video content is only substantially presented to one participant. For example, although the video of a participant may be displayed both in the participant's preview area 106 and in other participant's video area 302, audio of the participant is only presented to other participants. In addition, the audio/video content being transmitted as part of the videoconference is a fixed type that is determined automatically at the beginning of the videoconference session. In contrast, the shared content can be any of multiple content types that is determined based on what content has been selected for sharing at the time.

In general, the content viewers can be used to present multiple content types concurrently. For example, one participant can share content with other participants of the session while a second participant can simultaneously share content with the participants of the session. In such an example, two content viewers can be presented simultaneously thereby allowing of content of multiple types.

In the above description, for purposes of explanation, numerous specific details are set forth in order to provide a thorough understanding. It will be apparent, however, to one skilled in the art that implementations can be practiced without these specific details. In other instances, structures and devices are shown in block diagram form in order to avoid obscuring the disclosure.

In particular, one skilled in the art will recognize that other architectures and graphics environments can be used, and that the examples can be implemented using graphics tools and products other than those described above. In particular, the client/server approach is merely one example of an architecture for providing the functionality described herein; one skilled in the art will recognize that other, non-client/server approaches can also be used. Some portions of the detailed description are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

An apparatus for performing the operations herein can be specially constructed for the required purposes, or it can comprise a general-purpose computer selectively activated or reconfigured by a computer program stored in the computer. Such a computer program can be stored in a computer readable storage medium, such as, but is not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, and each coupled to a computer system bus.

The algorithms and modules presented herein are not inherently related to any particular computer or other apparatus. Various general-purpose systems can be used with programs in accordance with the teachings herein, or it can prove convenient to construct more specialized apparatuses to perform the method steps. The required structure for a variety of these systems will appear from the description. In addition, the present examples are not described with reference to any particular programming language. It will be appreciated that a variety of programming languages can be used to implement the teachings as described herein. Furthermore, as will be apparent to one of ordinary skill in the relevant art, the modules, features, attributes, methodologies, and other aspects can be implemented as software, hardware, firmware or any combination of the three. Of course, wherever a component is implemented as software, the component can be implemented as a standalone program, as part of a larger program, as a plurality of separate programs, as a statically or dynamically linked library, as a kernel loadable module, as a device driver, and/or in every and any other way known now or in the future to those of skill in the art of computer programming. Additionally, the present description is in no way limited to implementation in any specific operating system or environment.

The subject matter described in this specification can be implemented as one or more computer program products, i.e., one or more modules of computer program instructions encoded on a computer readable medium for execution by, or to control the operation of, data processing apparatus. The instructions can be organized into modules (or engines) in different numbers and combinations from the exemplary modules described. The computer readable medium can be a machine-readable storage device, a machine-readable storage substrate, a memory device, a composition of matter effecting a machine-readable propagated signal, or a combination of one or more them. The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal that is generated to encode information for transmission to suitable receiver apparatus.

While this specification contains many specifics, these should not be construed as limitations on the scope of what may be claimed, but rather as descriptions of features specific to particular implementations of the subject matter. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

The subject matter of this specification has been described in terms of particular embodiments, but other embodiments can be implemented and are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain implementations, multitasking and parallel processing may be advantageous. Other variations are within the scope of the following claims.

What is claimed is:

1. A method comprising:
receiving user input specifying a drag-and-drop operation, the drag-and-drop operation selecting a file containing content of a particular content type and dropping the file over a display area used to presenting video of participants in a videoconference session;
transmitting a portion of content to a participant of the videoconference; and
presenting the portion of content in a display area used for presenting video of participants in the videoconference.

2. The method of claim 1, further comprising:
presenting the portion of content without opening up an application used to create content of the particular content type.

3. The method of claim 1, where presenting the content further comprises:
using a generalized content viewer to view the content.

4. The method of claim 1, presenting the content further comprises:
providing user controls for navigating the presentation of content.

5. The method of claim 4, further comprising:
providing content-type specific user controls for navigating the presentation of content of the particular content type.

6. The method of claim 5, further comprising:
selecting the provided content-type specific user controls from a plurality of content-type specific user controls based on the particular content type, at least one user control in the plurality of content-type specific user controls being associated with a respective content type.

7. The method of claim 4, further comprising:
receiving user input from the provided user controls, the user input identifying one or more navigation operations;
updating the presentation of the content based on the one or more navigation operations; and
transmitting the one or more navigation operations to the participant of the video conference.

8. The method of claim 1, where selecting a file containing content further comprises browsing for and selecting a file in a file selection window.

9. A method comprising:
establishing a videoconference session between a first device operated by a first user and second device operated by a second user, the first device providing a first user interface window for presenting a video representation of the second user to the first user, the second device providing a second user interface window for presenting a video representation of the first user to the second user;
receiving input selecting a file on the first device;
receiving a request to share the selected file with the second user, the request being triggered when a representation of the file is dropped onto the representation of the second user;
transmitting content of the first file from the first device to the second device;
presenting in the first user interface window a first presentation of the content of the file; and
presenting in the second user interface window a second presentation of the content of the file, the first presentation and the second presentation presenting the same content of the file.

10. The method of claim 9, further comprising:
providing a control panel for navigating the presentation of the content in the second user interface window, the control panel being operable by the second user to affect the presentation of content being presented in the first user interface window, the second user interface window or both.

11. The method of claim 9, further comprising:
providing a control panel for navigating the presentation of the content in the first user interface window, the control panel being operable by the first user to affect the presentation of content being presented in the first user interface window, the second user interface window or both.

12. The method of claim 9, wherein the content is associated with a particular content type, the method further comprising:
selecting the control panel from a plurality of control panels, each control panel being associated with a respective content type, at least one control panel being usable to navigate a presentation of content of the content type associated with the respective control panel.

13. A system comprising:
one or more processors;
a computer-readable medium coupled to the one or more processors and including instructions, which, when executed by the one or more processors, causes the one or more processors to perform operations comprising:
receiving user input specifying a drag-and-drop operation, the drag-and-drop operation selecting a file containing content of a particular content type and dropping the file over a display area used to presenting video of participants in a videoconference session; and
transmitting a portion of content to a participant of the videoconference; and
presenting the portion of content in a display area used for presenting video of participants in the videoconference.

14. The system of claim 13, further comprising:
presenting the portion of content without opening up an application used to create content of the particular content type.

15. The system of claim 13, where presenting the content further comprises:
using a generalized content viewer to view the content.

16. The system of claim 13, presenting the content further comprises:
providing user controls for navigating the presentation of content.

17. The system of claim 16, further comprising:
providing content-type specific user controls for navigating the presentation of content of the particular content type.

18. The system of claim 17, further comprising:
selecting the provided content-type specific user controls from a plurality of content-type specific user controls based on the particular content type, at least one user control in the plurality of content-type specific user controls being associated with a respective content type.

19. The system of claim 16, further comprising:
receiving user input from the provided user controls, the user input identifying one or more navigation operations;
updating the presentation of the content based on the one or more navigation operations; and
transmitting the one or more navigation operations to the participant of the video conference.

20. A system comprising:
one or more processors;
one or more computer-readable mediums coupled to the one or more processors and including instructions, which, when executed by the one or more processors, causes the one or more processors to perform operations comprising:
establishing a videoconference session between a first device operated by a first user and second device operated by a second user, the first device providing a first user interface window for presenting a video representation of the second user to the first user, the second device providing a second user interface window for presenting a video representation of the first user to the second user;
receiving input selecting a file on the first device;
receiving a request to share the selected file with the second user, the request being triggered when a representation of the file is dropped onto the representation of the second user;
transmitting content of the first file from the first device to the second device;
presenting in the first user interface window a first presentation of the content of the file; and
presenting in the second user interface window a second presentation of the content of the file, the first presentation and the second presentation presenting the same content of the file.

21. The system of claim 20, further comprising:
providing a control panel for navigating the presentation of the content in the second user interface window, the control panel being operable by the second user to affect the presentation of content being presented in the first user interface window, the second user interface window or both.

22. The system of claim 20, further comprising:
providing a control panel for navigating the presentation of the content in the first user interface window, the control panel being operable by the first user to affect the presentation of content being presented in the first user interface window, the second user interface window or both.

23. The system of claim 22, wherein the content is associated with a particular content type, the method further comprising:
selecting the control panel from a plurality of control panels, each control panel being associated with a respective content type, at least one control panel being usable to navigate a presentation of content of the content type associated with the respective control panel.

24. A computer-readable medium having instructions stored thereon, which, when executed by one or more processors, causes the one or more processors to perform operations comprising:
receiving user input specifying a drag-and-drop operation, the drag-and-drop operation selecting a file containing content of a particular content type and dropping the file over a display area used to presenting video of participants in a videoconference session;
transmitting a portion of content to a participant of the videoconference; and
presenting the portion of content in a display area used for presenting video of participants in the videoconference.

25. The computer-readable medium of claim 24, further comprising:
presenting the portion of content without opening up an application used to create content of the particular content type.
